(19) United States
(12) Patent Application Publication
(10) Pub. No.: US 2024/0296696 A1
(43) Pub. Date: Sep. 5, 2024

(54) ABNORMALITY JUDGMENT DEVICE, ABNORMALITY JUDGMENT METHOD, AND ABNORMALITY JUDGMENT PROGRAM

(71) Applicant: NIPPON TELEGRAPH AND TELEPHONE CORPORATION, Tokyo (JP)

(72) Inventors: Motohiro TAKAGI, Tokyo (JP); Kazuya YOKOHARI, Tokyo (JP); Masaki KITAHARA, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/574,739

(22) PCT Filed: Jun. 29, 2021
(86) PCT No.: PCT/JP2021/024477

§ 371 Date: Dec. 27, 2023

(51) Int. Cl. G06V 40/20; G06T 7/215; G06T 7/246; G06V 10/74; G06V 10/77; G06V 20/40

(52) U.S. Cl. CPC G06V 40/23; G06T 7/215; G06T 7/246; G06V 10/761; G06V 10/7715; G06V 20/46; G06T 2207/10016; G06T 2207/20081; G06T 2207/30196

(57) ABSTRACT

An object detection unit 60 detects appearance features related to an object near the person and an appearance of the person, person region information related to a region representing the person, and object region information related to a region representing the object from video data representing a motion of a person. A motion feature extraction unit 62 extracts a motion feature related to the motion of the person based on the video data and the person region information. A relational feature extraction unit 64 extracts a relational feature indicating a relationship between the object and the person based on the object region information and the person region information. The abnormality determination unit 66 determines whether the motion of the person is abnormal based on the appearance feature, the motion feature, and the relational feature.

### TECHNICAL FIELD

The technology of the present disclosure relates to an abnormality determination device, an abnormality determination method, and an abnormality determination program.

### BACKGROUND ART

In recent years, with the spread of high-definition cameras, there has been an increasing need for a technique for analyzing a motion of a person with a captured image. For example, the technique is for detecting a criminal motion by a monitoring camera, detection of a dangerous motion at a construction site, and the like. To discover these motions, it is necessary to look at a large amount of video footage. A person who understands the definition of an abnormal motion observes the motion in the video to detect an abnormal motion. However, since manual detection is time-and labor-intensive, a method of detecting an abnormal motion by constructing an algorithm for automatic detection is conceivable.

In recent years, a technique for detecting an abnormal motion using a neural network has been proposed (Non Patent Literature 1). In the method of Non Patent Literature 1, abnormal motion is detected with high accuracy by clustering videos.

### CITATION LIST

### Non Patent Literature

Non Patent Literature 1: Zaheer M. Z., Mahmood A., Astrid M., Lee S I. CLAWS: Clustering Assisted Weakly Supervised Learning with Normalcy Suppression for Anomalous Event Detection. ECCV 2020.

### SUMMARY OF INVENTION

### Technical Problem

In the conventional method for detecting an abnormal motion appearing in an image described in Non Patent Literature 1, a relationship between a person and an object is not considered. Therefore, for example, in a case where there are procedures of (Procedure 1) erecting a stepladder on a floor, (Procedure 2) tightening a safety belt, and (Procedure 3) climbing a stepladder, there are motions related to a large number of objects in each procedure, and motions related to such objects may lead to an accident, but are not explicitly considered. Specifically, in Procedure 1, a motion such as a person letting his/her hand and losing his/her posture when climbing a stepladder is dangerous. When a motion that usually does not occur leading to such danger is regarded as an abnormal motion, it is difficult to detect the abnormal motion by the conventional method.

The disclosed technology has been made in view of the above points, and an object thereof is to provide an abnormality determination device, a method, and a program capable of accurately determining an abnormality of a motion of the person.

### Solution to Problem

A first aspect of the present disclosure is an abnormality determination device including an object detection unit that detects appearance features related to an object near a person and an appearance of the person, person region information related to a region representing the person, and object region information related to a region representing the object from video data representing a motion of the person, a motion feature extraction unit that extracts a motion feature related to a motion of the person based on the video data and the person region information, a relational feature extraction unit that extracts a relational feature indicating a relationship between the object and the person based on the object region information and the person region information, and an abnormality determination unit that determines whether the motion of the person is abnormal based on the appearance feature, the motion feature, and the relational feature.

A second aspect of the present disclosure is an abnormality determination method including causing an object detection unit to detect appearance features related to an object near a person and an appearance of the person, person region information related to a region representing the person, and object region information related to a region representing the object from video data representing a motion of the person, causing a motion feature extraction unit to extract a motion feature related to a motion of the person based on the video data and the person region information, causing a relational feature extraction unit to extract a relational feature indicating a relationship between the object and the person based on the object region information and the person region information, and causing an abnormality determination unit to determine whether the motion of the person is abnormal based on the appearance feature, the motion feature, and the relational feature.

A third aspect of the present disclosure is an abnormality determination program for causing a computer to function as the abnormality determination device of the first aspect.

### Advantageous Effects of Invention

According to the disclosed technology, it is possible to accurately determine abnormality of a motion of a person.

### BRIEF DESCRIPTION OF DRAWINGS

FIG. 1 is a schematic block diagram of an example of a computer functioning as a learning device and an abnormality determination device according to the present embodiment.

FIG. 2 is a block diagram illustrating a configuration of a learning device of the present embodiment.

FIG. 3 is a block diagram illustrating a configuration of the abnormality determination device of the present embodiment.

FIG. 4 is a flowchart illustrating a learning processing routine of the learning device according to the present embodiment.

FIG. 5 is a flowchart illustrating a flow of object detection processing of the abnormality determination device according to the present embodiment.

FIG. 6 is a flowchart illustrating a flow of motion feature extraction processing of the abnormality determination device according to the present embodiment.

FIG. 7 is a flowchart illustrating a flow of relational feature extraction processing of the abnormality determination device according to the present embodiment.

FIG. 8 is a flowchart illustrating a flow of abnormality determination processing of the abnormality determination device according to the present embodiment.

### DESCRIPTION OF EMBODIMENTS

Hereinafter, an example of an embodiment of the disclosed technology will be described with reference to the drawings. In the drawings, the same or equivalent components and parts will be denoted by the same reference signs. In addition, dimensional ratios in the drawings are exaggerated for convenience of description, and may be different from actual ratios.

### Overview of Present Embodiment

In the present embodiment, an image segment representing a motion of a person is input to detect an object near the person, an appearance feature of the person, person region information, and object region information, the image segment and the person region information are input to extract a motion feature, the person region information and the object region information are input to extract a relational feature, and the appearance feature, the motion feature, and the relational feature are input to determine an abnormality in the motion of the person.

Here, the motion of the person includes not only the motion of the person acting on the object but also the motion of the person not acting on the object.

### Configuration of Learning Device According to Present Embodiment

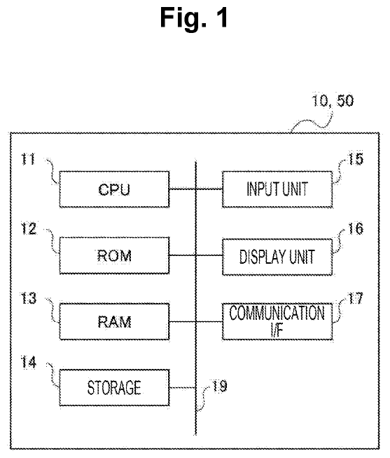

FIG. 1 is a block diagram showing a hardware configuration of a learning device 10 according to the present embodiment.

As illustrated in FIG. 1, the learning device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, and executes various programs and controls each unit. That is, the CPU 11 reads the programs from the ROM 12 or the storage 14 and executes the programs by using the RAM 13 as a work area. The CPU 11 performs control of each of the above-described components and various types of operation processing according to a program stored in the ROM 12 or the storage 14. In the present embodiment, a learning program is stored in the ROM 12 or the storage 14. The learning program may be one program or a group of programs including a plurality of programs or modules.

The ROM 12 stores various programs and various types of data. The RAM 13 temporarily stores a program or data as a working area. The storage 14 includes a hard disk drive (HDD) or a solid state drive (SSD) and stores various programs including an operating system and various types of data.

The input unit 15 includes a pointing device such as a mouse and a keyboard and is used to perform various inputs.

The input unit 15 receives learning video data as an input. Specifically, the input unit 15 receives learning video data indicating a motion of a person. Training data representing the object type and the object region, training data representing the motion type, and a label indicating whether the motion of the person is abnormal or normal are applied to the learning video data.

The display unit 16 is, for example, a liquid crystal display and displays various types of information. The display unit 16 may function as the input unit 15 by employing a touchscreen system.

The communication interface 17 is an interface for communicating with another device, and for example, standards such as Ethernet®, FDDI, and Wi-Fi® are used.

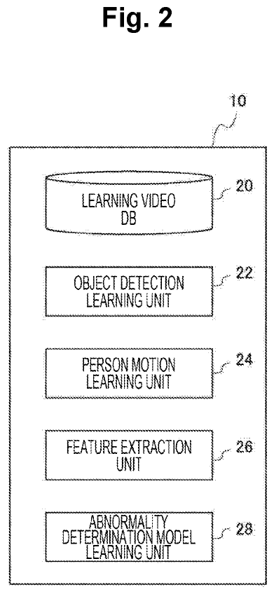

Next, functional configurations of the learning device 10 will be described. FIG. 2 is a block diagram illustrating an example of a functional configuration of the learning device 10.

As illustrated in FIG. 2, the learning device 10 functionally includes a learning video database (DB) 20, an object detection learning unit 22, a person motion learning unit 24, a feature extraction unit 26, and an abnormality determination model learning unit 28.

The learning video database 20 stores a plurality of pieces of input learning video data. The learning video data may be input for each video, may be input for each divided video segment, or may be input for each video frame. Here, the video segment is a unit in which a video is collectively divided into a plurality of frames, and is, for example, a unit in which 32 frames are defined as one segment.

The object detection learning unit 22 uses the learning video segment group stored in the learning video database 20 as an input, learns an object detection model for detecting an object from a video segment, and outputs a learned object detection model. The learning may be performed for each frame of the video. When the number of frames of the video is large and learning takes time, sampling may be performed randomly.

Specifically, the object detection model is a machine learning model such as a neural network that determines an object type represented by a bounding box based on an appearance feature of the bounding box of the video data. For example, the object detection model is an object detector in a neural network as in Non Patent Literature 2, and detects a person or an object with a rectangle (bounding box) and determines an object type.

Non Patent Literature 2: S. Ren et al. Faster R-CNN: Towards Real-Time Object Detection with Region Proposal Networks. NIPS2015.

The object detection learning unit 22 learns the object detection model to optimize the loss calculated from the object type and the object region indicated by the training data for each of the learning video segments and the output of the object detection model.

The person motion learning unit 24 receives the learning video segment group stored in the learning video database 20 as an input, learns a motion recognition model for recognizing a motion of a person from the video segments, and outputs a learned motion recognition model. The learning may be performed for each frame of the video. When the number of frames of the video is large and learning takes time, sampling may be performed randomly.

Specifically, the motion recognition model is a machine learning model such as a neural network that recognizes a motion type based on a motion feature of a person region of video data. The person motion learning unit 24 learns the motion recognition model to optimize the loss calculated from the motion type represented by the training data for each of the learning video segments and the output of the motion recognition model.

The feature extraction unit 26 uses the learning video segment group, the learned object detection model, and the learned motion recognition model stored in the learning video database 20 as inputs, and extracts learning feature information for each of the learning video segments. The learning feature information includes an appearance feature regarding an object near a person and an appearance of the person, a motion feature regarding a motion of the person, and a relational feature indicating a relationship between the object and the person.

Specifically, for each of the learning video segments, the feature extraction unit 26 extracts an appearance feature regarding an object near a person and an appearance of the person obtained using the learned object detection model, a motion feature extracted using the learned motion recognition model, and a relational feature indicating a relationship between the object and the person obtained based on the object region information and the person region information, and generates learning feature information that is a vector obtained by combining the appearance feature, the motion feature, and the relational feature.

The person region information is bounding box information representing a person, and the object region information is bounding box information representing an object. The appearance feature is a feature vector for detecting a bounding box of each object described in Non Patent Literature 2, and is a feature obtained by combining or integrating the appearance feature of the object and the appearance feature of the person. The person region information, the object region information, and the appearance feature are acquired for each frame of the video, and the detection result in the frame at any time of the video segment is used. Alternatively, an average of a certain section may be used.

The abnormality determination model learning unit 28 learns the abnormality determination model based on the learning feature information for each of the learning video segments and the training data, and outputs the learned abnormality determination model.

Specifically, the abnormality determination model is a machine learning model such as a neural network that outputs an abnormality score using the feature information as an input. The abnormality determination model learning unit 28 learns the abnormality determination model to optimize the loss calculated from the label for each of the learning video segments and the output of the abnormality determination model.

### Configuration of Abnormality Determination Device According to Present Embodiment

FIG. 1 is a block diagram illustrating a hardware configuration of an abnormality determination device 50 according to the present embodiment.

As illustrated in FIG. 1, the abnormality determination device 50 has a configuration similar to that of the learning device 10, and an abnormality determination program for determining an abnormal motion is stored in the ROM 12 or the storage 14.

The input unit 15 receives video data representing a motion of a person as an input.

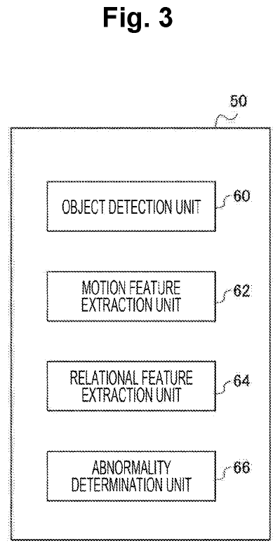

Next, a functional configuration of the abnormality determination device 50 will be described. FIG. 3 is a block diagram illustrating an example of a functional configuration of the abnormality determination device 50.

As illustrated in FIG. 3, the abnormality determination device 50 functionally includes an object detection unit 60, a motion feature extraction unit 62, a relational feature extraction unit 64, and an abnormality determination unit 66.

The object detection unit 60 holds a learned object detection model, and detects an appearance feature related to an object near a person and an appearance of the person, person region information related to a region representing the person, and object region information related to a region representing the object by using the learned object detection model from a video segment representing a motion of the person.

The appearance feature includes a feature related to appearance of each object and a feature related to appearance of a person, which are obtained in determining the object type by using the learned object detection model.

The motion feature extraction unit 62 holds the learned motion recognition model, and extracts a motion feature related to the motion of the person using the learned motion recognition model based on the video segment and the person region information. The motion feature is a feature extracted when the motion is recognized by the motion recognition model.

A relational feature extraction unit 64 extracts a relational feature indicating a relationship between the object and the person based on the object region information and the person region information. In a case where there are a plurality of objects around a person, the relational feature is a vector representing a distance between the person and each of the objects.

The abnormality determination unit 66 holds the learned abnormality determination model, determines whether the motion of the person is abnormal using the learned abnormality determination model based on the feature information indicating the appearance feature, the motion feature, and the relational feature, and outputs a motion abnormality label indicating whether the motion of the person is abnormal. Here, the motion abnormality label is a binary label, and in the present embodiment, in a case where the motion abnormality label is 1, it indicates that the motion is abnormal, and in a case where the motion abnormality label is 0, it indicates that the motion is normal.

### Operation of Learning Device According to Present Embodiment

Next, an operation of the learning device 10 according to the present embodiment will be described.

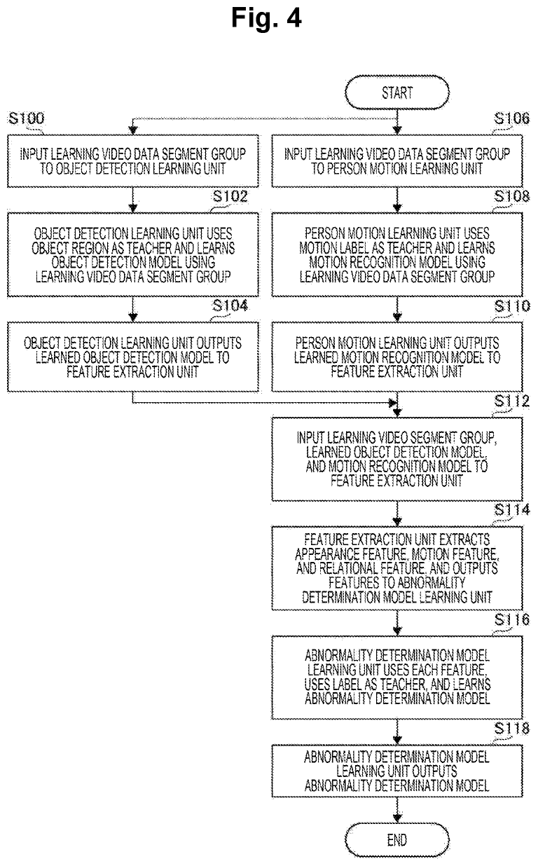

FIG. 4 is a flowchart showing a flow of learning processing by the learning device 10. Learning processing is performed by the CPU 11 reading a learning program from the ROM 12 or the storage 14, developing the learning program in the RAM 13, and executing the learning program. Furthermore, a plurality of pieces of video data for learning is input to the learning device 10 and stored in the learning video database 20.

In step S100, the CPU 11 inputs the learning video data segment group stored in the learning video database 20 to the object detection learning unit 22.

In step S102, as the object detection learning unit 22, the CPU 11 learns the object detection model by using the object type and the training data indicating the object region based on the learning video data segment group. Here, the object region is bounding box information.

In step S104, the CPU 11 outputs the learned object detection model to the feature extraction unit 26 as the object detection learning unit 22.

In step S106, the CPU 11 inputs the learning video data segment group stored in the learning video database 20 to the person motion learning unit 24.

In step S108, as the person motion learning unit 24, the CPU 11 learns the motion recognition model using the training data indicating the motion type based on the learning video data segment group. Here, the motion type of the training data includes a motion of a person such as walking or running.

In step S110, the CPU 11 outputs the learned motion recognition model to the feature extraction unit 26 as the person motion learning unit 24.

Note that the processing of steps S100 to S104 and the processing of steps S106 to S110 may be performed in parallel. Furthermore, in a case where a model learned in advance with a large-scale open data set is used as the motion recognition model, the processing of steps S106 to S110 may be omitted.

In step S112, the CPU 11 inputs the learning video segment group, the learned object detection model, and the learned motion recognition model to the feature extraction unit 26.

In step S114, as the feature extraction unit 26, the CPU 11 extracts the appearance feature, the motion feature, and the relational feature for each of the learning video segments to generate learning feature information, and outputs the learning feature information to the abnormality determination model learning unit 28.

In step S116, as the abnormality determination model learning unit 28, the CPU 11 learns the abnormality determination model for each of the learning video segments using a label indicating whether the motion of the person is abnormal or normal based on the learning feature information.

In step S118, the CPU 11 outputs the learned abnormality determination model as the abnormality determination model learning unit 28.

### Operation of Abnormality Determination Device According to Present Embodiment

Next, the operation of the abnormality determination device 50 according to the present embodiment will be described.

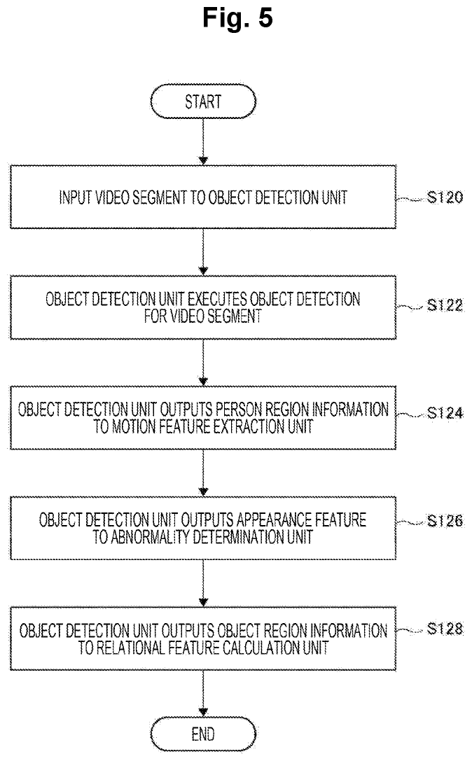

FIG. 5 is a flowchart illustrating a flow of object detection processing by the abnormality determination device 50. The CPU 11 reads out the abnormality determination program from the ROM 12 or the storage 14, develops the program in the RAM 13, and executes the program, whereby the object detection processing in the abnormality determination processing is performed. In addition, video data representing a motion of a person is input to the abnormality determination device 50, and the object detection processing is repeatedly performed for each video segment of the video data.

In step S120, the CPU 11 inputs the video segment of the video data to the object detection unit 60.

In step S122, as the object detection unit 60, the CPU 11 executes the object detection on the video segment using the learned object detection model. Here, object detection may be performed for all frames and one frame may be extracted, or frames to be detected, such as a head frame and an intermediate frame of a segment, may be determined in advance. Alternatively, a method may be used in which a frame in which both a person and an object appear is detected as a condition, and a frame having the largest number of objects is taken out.

In step S124, the CPU 11 outputs the person region information obtained by the object detection to the motion feature extraction unit 62 as the object detection unit 60.

In step S126, the CPU 11 outputs the appearance feature obtained by the object detection to the abnormality determination unit 66 as the object detection unit 60. The appearance feature includes a person appearance feature and an object appearance feature, and is specifically a vector obtained by combining or integrating a person feature vector and an object feature vector used for determining the object type in the bounding box.

In step S128, as the object detection unit 60, the CPU 11 outputs the person region information and the object region information obtained by the object detection to the relational feature extraction unit 64. Here, the person region information is bounding box information including a person, and the object region information is bounding box information including an object.

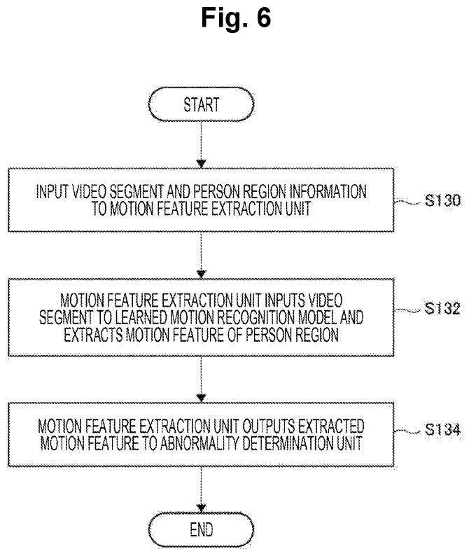

FIG. 6 is a flowchart illustrating a flow of motion feature extraction processing by the abnormality determination device 50. The CPU 11 reads out the abnormality determination program from the ROM 12 or the storage 14, develops the program in the RAM 13, and executes the program, whereby the motion feature extraction processing in the abnormality determination processing is performed. The motion feature extraction processing is repeatedly performed for each video segment of the video data.

In step S130, the CPU 11 inputs the video segment and the person region information to the motion feature extraction unit 62.

In step S132, as the motion feature extraction unit 62, the CPU 11 inputs the video segment and the person region information to the learned motion recognition model and extracts the motion feature of the person region. The motion feature is obtained by extracting the motion feature from the pre-learned motion recognition model of the person region. The motion recognition model is a motion recognition model as disclosed in Non Patent Literature 3. The motion feature is obtained by extracting an output or the like of the final fully connected layer, which is feature extraction generally used in a neural network, as a feature vector.

Non Patent Literature 3: C. Feichtenhofer et al. SlowFast Networks for Video Recognition. ICCV2019.

In step S134, as the motion feature extraction unit 62, the CPU 11 outputs the extracted motion feature to the abnormality determination unit 66 and ends the processing.

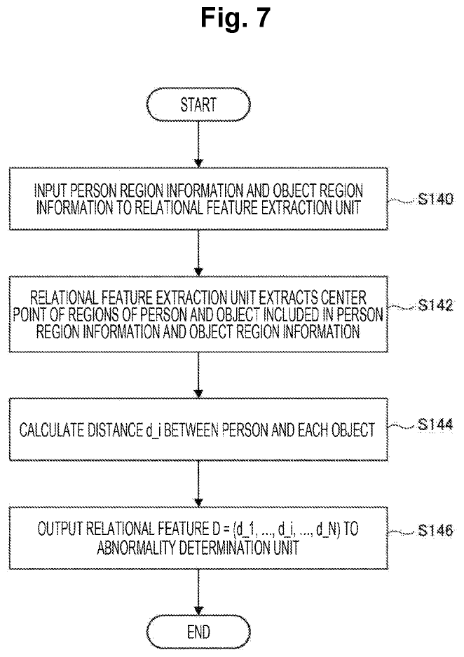

FIG. 7 is a flowchart illustrating a flow of relational feature extraction processing by the abnormality determination device 50. The CPU 11 reads out the abnormality determination program from the ROM 12 or the storage 14, develops the program in the RAM 13, and executes the program, whereby the relational feature extraction processing in the abnormality determination processing is performed. The relational feature extraction processing is repeatedly performed for each video segment of the video data.

In step S140, the CPU 11 inputs the person region information and the object region information to the relational feature extraction unit 64.

In step S142, as the relational feature extraction unit 64, the CPU 11 extracts the center point of the object region included in the object region information and the center point of the person area included in the person region information.

In step S144, as the relational feature extraction unit 64, the CPU 11 calculates a distance d_i between the person and each object i. For example, when the position of the center point of the bounding box that is a person region is (x_h, y_h) and the position of the center point of the bounding box that is a certain object region is (x_o, y_o), it can be expressed as d_i=(|x_h−x_o|, |y_h−y_o|).

In step S146, as the relational feature extraction unit 64, the CPU 11 outputs the relational feature D=(d_1, . . . , d_i, . . . , d_N) in which the distance between the person and each object is collected to the abnormality determination unit 66, and the processing ends. Here, N is the maximum number of objects, the class of each object to be detected is determined in advance, and each dimension of the relational feature D is the distance of which object class. In the present embodiment, an unknown object is not detected, but in a case where an unknown object is detected, an unknown object class may be provided.

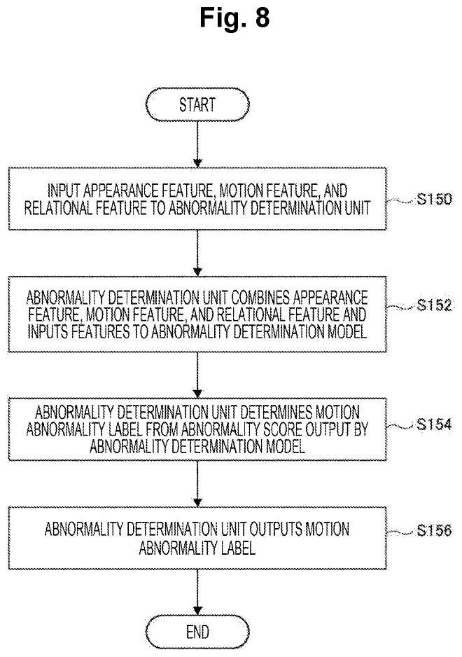

FIG. 8 is a flowchart illustrating a flow of abnormality determination processing by the abnormality determination device 50. The determination processing of the abnormality determination processing is performed by the CPU 11 reading out the abnormality determination program from the ROM 12 or the storage 14, and loading and executing the abnormality determination program in the RAM 13. The determination processing is repeatedly performed for each video segment of the video data.

In step S150, the CPU 11 inputs the appearance feature, the motion feature, and the relational feature to the abnormality determination unit 66.

In step S152, as the abnormality determination unit 66, the CPU 11 combines the appearance feature, the motion feature, and the relational feature, generates feature information, and inputs the feature information to the learned abnormality determination model.

In step S154, as the abnormality determination unit 66, the CPU 11 determines whether the motion of the person is abnormal or normal from the abnormality score output by the learned abnormality determination model based on the feature information.

In step S156, the CPU 11 outputs a motion abnormality label indicating the determination result in step S154 as the abnormality determination unit 66.

Here, the abnormality determination unit 66 may simply combine the respective features to generate the feature information, or may perform processing according to the features on the respective features and then combine the features to generate the feature information. For example, when focusing on the relational feature, how the relationship between the person and the object changes in time series may be important. In such a case, the abnormality determination unit 66 may add the processing of the neural network incorporating the time-series information as in Non Patent Literature 4, and reflect the time-series information in the feature information by taking into account a so-called context with both the relational features of the past time t-1 and the current time t as inputs.

Non Patent Literature 4: S. Hochreiter and J. Schmidhuber. Long Short-Term Memory. Neural Computation, volume 9, 1997.

In addition, a certain section from the past time t-p to the current time t may be combined and used as the relational feature. In a case where the past relational feature is used, the abnormality determination model has a function of holding the past feature.

As described above, the abnormality determination device according to the present embodiment extracts appearance features related to an object near a person and appearance of the person, motion features related to a motion of the person, and relational features indicating a relationship between the object and the person from video data indicating motion of the person, and determines whether the motion of the person is abnormal. Accordingly, the abnormality of the motion of the person can accurately be determined in consideration of the relationship with the object near the person.

In addition, it is possible to identify a situation in which an abnormality is likely to occur in work including a motion of a person related to an object, and to determine the abnormality of the motion of the person.

### Modification Examples

Note that the present invention is not limited to the above-described embodiments, and various modifications and applications can be made without departing from the gist of the present invention.

For example, a case where the learning device and the abnormality determination device are configured as separate devices has been described as an example, but the present invention is not limited thereto, and the learning device and the abnormality determination device may be configured as one device.

In addition, various processes executed by the CPU reading software (program) in each of the above embodiments may be executed by various processors other than the CPU. Examples of the processors in this case include a graphics processing unit (GPU), a programmable logic device (PLD) whose circuit configuration can be changed after the manufacturing, such as a field-programmable gate array (FPGA), and a dedicated electric circuit that is a processor having a circuit configuration exclusively designed for executing specific processing, such as an application specific integrated circuit (ASIC). Furthermore, the learning processing and the abnormality determination processing may be executed by one of these various processors, or may be performed by a combination of two or more processors of the same type or different types (for example, a plurality of FPGAs, a combination of a CPU and an FPGA, and the like). More specifically, a hardware structure of the various processors is an electric circuit in which circuit elements such as semiconductor elements are combined.

Furthermore, in the above embodiments, the aspect in which the learning program and the abnormality determination program are stored (installed) in advance in the storage 14 has been described, but the present invention is not limited thereto. The program may be provided in the form of a program stored in a non-transitory storage medium such as a compact disk read only memory (CD-ROM), a digital versatile disk read only memory (DVD-ROM), or a universal serial bus (USB) memory. The program may be downloaded from an external device via a network.

With regard to above embodiment, the following supplementary items are further disclosed.

### Supplementary Item 1

An abnormality determination device including
a memory, and
at least one processor connected to the memory, in which processor is configured to
detect appearance features related to an object near a person and an appearance of the person, person region information related to a region representing the person, and object region information related to a region representing the object from video data representing a motion of the person,
extract a motion feature related to a motion of the person based on the video data and the person region information,
extract a relational feature indicating a relationship between the object and the person based on the object region information and the person region information, and
determine whether the motion of the person is abnormal based on the appearance feature, the motion feature, and the relational feature.

### Supplement Item 2

A non-transitory storage medium storing a program executable by a computer to execute abnormality determination processing, in which
the abnormality determination process includes
detecting appearance features related to an object near a person and an appearance of the person, person region information related to a region representing the person, and object region information related to a region representing the object from video data representing a motion of the person,
extracting a motion feature related to a motion of the person based on the video data and the person region information,
extracting a relational feature indicating a relationship between the object and the person based on the object region information and the person region information, and
determining whether the motion of the person is abnormal based on the appearance feature, the motion feature, and the relational feature.

### Reference Signs List

10 Learning device
11 CPU
14 Storage
15 Input unit
16 Display unit
20 Learning video database
22 Object detection learning unit
24 Person motion learning unit
26 Feature extraction unit
28 Abnormality determination model learning unit
50 Abnormality determination device
60 Object detection unit
62 Motion feature extraction unit
64 Relational feature extraction unit
66 Abnormality determination unit

1. An abnormality determination device comprising a processor configured to execute operations comprising:
detecting an appearance feature of an object near a person and an appearance of the person, person region information of a region representing the person, and object region information of a region representing the object from video data representing a motion of the person;
extracting a motion feature of a motion of the person based on the video data and the person region information;
extracting a relational feature indicating a relationship between the object and the person based on the object region information and the person region information; and
determining whether the motion of the person is abnormal based on the appearance feature, the motion feature, and the relational feature.

2. The abnormality determination device according to claim 1, wherein the appearance feature includes a feature of appearance of each of the objects and a feature of appearance of the person, which are obtained when an object type is determined.

3. The abnormality determination device according to claim 1, wherein the motion feature is a feature extracted by a motion recognition model for recognizing a motion represented by video data.

4. The abnormality determination device according to claim 1, wherein the relational feature includes a distance between the person and each of the objects.

5. A computer implemented method for determining abnormality, comprising:
detecting an appearance feature of an object near a person and an appearance of the person, person region information of a region representing the person, and object region information of a region representing the object from video data representing a motion of the person;
extracting a motion feature a motion of the person based on the video data and the person region information;
extracting a relational feature indicating a relationship between the object and the person based on the object region information and the person region information; and
determining whether the motion of the person is abnormal based on the appearance feature, the motion feature, and the relational feature.

6. A computer-readable non-transitory recording medium storing a computer-executable program instructions that when executed by a processor cause a computer to execute operations comprising:
detecting an appearance feature of an object near a person and an appearance of the person, person region information of a region representing the person, and object region information of a region representing the object from video data representing a motion of the person;
extracting a motion feature of a motion of the person based on the video data and the person region information;
extracting a relational feature indicating a relationship between the object and the person based on the object region information and the person region information; and
determining whether the motion of the person is abnormal based on the appearance feature, the motion feature, and the relational feature.

7. The abnormality determination device according to claim 2, wherein the motion feature is a feature extracted by a motion recognition model for recognizing a motion represented by video data.

8. The abnormality determination device according to claim 2, wherein the relational feature includes a distance between the person and each of the objects.

9. The abnormality determination device according to claim 3, wherein the motion recognition model is based on a machine learning model, and the machine learning model detects an object with a bounding box and determines an object type.

10. The computer implemented method according to claim 5, wherein the appearance feature includes a feature of appearance of each of the objects and a feature of appearance of the person, which are obtained when an object type is determined.

11. The computer implemented method according to claim 5, wherein the motion feature is a feature extracted by a motion recognition model for recognizing a motion represented by video data.

12. The computer implemented method according to claim 5, wherein the relational feature includes a distance between the person and each of the objects.

13. The computer implemented method according to claim 10, wherein the motion feature is a feature extracted by a motion recognition model for recognizing a motion represented by video data.

14. The computer implemented method according to claim 10, wherein the relational feature includes a distance between the person and each of the objects.

15. The computer implemented method according to claim 11, wherein the motion recognition model is based on a machine learning model, and the machine learning model detects an object with a bounding box and determines an object type.

16. The computer-readable non-transitory recording medium according to claim 6, wherein the appearance feature includes a feature of appearance of each of the objects and a feature of appearance of the person, which are obtained when an object type is determined.

17. The computer-readable non-transitory recording medium according to claim 6, wherein the motion feature is a feature extracted by a motion recognition model for recognizing a motion represented by video data.

18. The computer-readable non-transitory recording medium according to claim 6, wherein the relational feature includes a distance between the person and each of the objects.

19. The computer-readable non-transitory recording medium according to claim 16, wherein the motion feature is a feature extracted by a motion recognition model for recognizing a motion represented by video data.

20. The computer-readable non-transitory recording medium according to claim 17, wherein the motion recognition model is based on a machine learning model, and the machine learning model detects an object with a bounding box and determines an object type.
